(19) United States
(12) Patent Application Publication
(10) Pub. No.: US 2009/0167915 A1
(43) Pub. Date: Jul. 2, 2009

(54) SOLID-STATE IMAGING DEVICE AND DRIVING METHOD OF THE SAME

(75) Inventors: Masayuki Hirota, Kyoto (JP); Masashi Murakami, Kyoto (JP)

Correspondence Address: GREENBLUM & BERNSTEIN, P.L.C., 1950 ROLAND CLARKE PLACE, RESTON, VA, 20191, US

(73) Assignee: Panasonic Corporation, Osaka (JP)

(21) Appl. No.: 12/335,647

(22) Filed: Dec. 16, 2008

(30) Foreign Application Priority Data
Dec. 26, 2007 (JP) 2007-334884

(51) Int. Cl. H04N 3/14

(52) U.S. Cl. 348/302; 348/E03.014

(57) ABSTRACT

Provided is a solid-state imaging device being capable of suppressing RTS noise and preventing decrease in S/N when a signal having a smaller value is converted to a digital signal. The solid-state imaging device includes: an imaging unit including pixels arranged in rows and columns; column amplifying units each amplifying a column signal with a variable gain, each of the column amplifying units being provided for each column of the imaging unit; column sample-hold units each selectively sample-holding and passing the column signal, the column signal being amplified by a corresponding one of the column amplifying units; and column AD conversion units each converting, using a ramp signal, the column signal representing a signal component and a reference component to a digital signal corresponding to a difference between the signal component and the reference component, the column signal being read from a corresponding one of said column sample-hold units.

### BACKGROUND OF THE INVENTION

(1) Field of the Invention

The present invention relates to a solid-state imaging device that generates a signal corresponding to an amount of incident light and a driving method of the same, and in particular to a solid-state imaging device including column AD conversion units.

(2) Description of the Related Art

Conventionally, MOS solid-state imaging devices (image sensors) including column AD conversion units using a coupled double sampling structure (digital CDS) have been suggested (for example, see Japanese Unexamined Patent Application Publication No. 2005-323331).

FIG. 9 is a circuit block diagram illustrating a structure of a conventional solid-state imaging device 9. This solid-state imaging device 9 includes an imaging unit 10 and a column processing unit 90.

The imaging unit 10 includes pixels 11 that are arranged in rows and columns, and generates a signal corresponding to an amount of light incident on each of the pixels 11, from a corresponding one of the pixels 11 in a row selected by a row selecting line 12 to each of column signal lines 13. The signal generated to each of the column signal lines 13 (hereinafter referred to as “column signal” or “pixel signal”) includes a reference component corresponding to an offset voltage for resetting each of the pixels 11, and a signal component corresponding to a voltage obtained by adding a component corresponding to the light incident on each of the pixels 11 to the reference component.

The column processing unit 90 is a collection of column AD conversion units 31 each converting a column signal using a digital CDS. Each of the column AD conversion units 31 converts the column signal representing a signal component and a reference component to a digital signal corresponding to a difference between the signal component and the reference component. The difference is a net signal corresponding to an amount of light incident on each of the pixels 11. Each of the column AD conversion units 31 includes a comparator 32 and an up-down counter 33. The comparator 32 compares a voltage of a column signal with a voltage of a reference signal Vr received as a ramp signal, and generates a signal representing timing when the voltage of the reference signal Vr matches the voltage of the column signal. The up-down counter 33 counts down (or counts up) a clock signal during a period elapsed from a time when the reference signal Vr is applied to the comparator 32 to a time when the reference signal Vr reaches a voltage of a column signal representing a reference component, and then counts up (or counts down) the clock signal during a period elapsed from a time when the reference signal Vr is applied to the comparator 32 to a time when the reference signal Vr reaches a voltage of a column signal representing a signal component. Thereby, the up-down counter 33 can hold a digital value corresponding to a difference between the signal component and the reference component of the column signal.

The digital value held by each of the up-down counters 33 is respectively transmitted to a horizontal signal line 40 including N buses, and the digital value is transmitted outside via an output circuit (output buffer) 41.

The conventional solid-state imaging device 9 including column AD conversion units using a digital CDS can digitally reduce noise, such as fixed pattern noise caused by an offset voltage in a pixel. Furthermore, the conventional solid-state imaging device 9 needs only one counter per line of an imaging unit for calculating the difference between the reference component and the signal component included in each of the column signals. Thus, compared to a structure including a plurality of counters, a digital CDS can be implemented with a smaller circuit scale in the conventional solid-state imaging device 9.

However, the conventional solid-state imaging device 9 has a problem of being incapable of sufficiently suppressing Random Telegraph Signal (RTS) noise generated from pixels, due to variations of sampling periods of column signals in the column AD conversion units depending on amplitude of each of the column signals. Here, the sampling period refers to a time period for determining analog information (generally, a voltage) of a signal applied to the column AD conversion units. Furthermore, the RTS noise refers to: noise generated from a MOS solid-state imaging device due to input and output of carriers to and from a trap at an Si interface of the solid-state imaging device; and noise observed as a fluctuation of a drain voltage of the MOS transistor in the solid-state imaging device. Such noise appears as flickering dots of a higher intensity on a screen under low light conditions, and causes images to be seriously degraded.

FIG. 10 is a timing chart for explaining a problem of the conventional solid-state imaging device 9. The timing chart indicates timing of operations using the digital CDS in the solid-state imaging device 9. The digital CDS sampling period of a column signal representing a signal component Vsig (pixel signal Vx in FIG. 10) as in FIG. 10 refers to a period elapsed from a time when a reference component Vref is converted to a digital signal to a time when the signal component Vsig is converted to a digital signal. This period becomes an extremely long period with a characteristic that occurrence probability of RTS noise increases as a sampling period becomes longer. Thus, the conventional solid-state imaging devices have a problem of being incapable of sufficiently reducing the RTS noise and in particular a problem of varying in an intensity level (flicker of light) under low light conditions.

Furthermore, the conventional solid-state imaging devices have a problem of decrease in a signal to noise ratio (abbreviated hereinafter as S/N) through conversion of an column signal to a digital signal when the signal component Vsig of the column signal have a smaller value. This problem occurs because: comparisons performed by each of the comparators 32 becomes unstable when an input signal to each of the column AD conversion units 31 has a smaller voltage, thus lowering the comparison precision; and each of the up-down counters 33 that operates in conjunction with the comparators 32 has a smaller value.

In order to solve these problems, as shown in FIG. 10, a slope of the reference signal Vr received as a ramp signal may be changed (ramp signals 11 to 14 in FIG. 10) according to amplitude of the signal component Vsig. For example, when the signal component Vsig has a smaller value, the slope of the reference signal Vr is reduced. As a result, a larger digital value can be obtained. However, even with such digital amplification, each of the comparators 32 compares small voltages, causing decrease in S/N due to lowered comparison precision.

Thus, the present invention has been conceived in view of these circumstances, and has an object of providing a solid-state imaging device including column AD conversion units, and a driving method of the same. With the solid-state imaging device and the driving method of the same, RTS noise can be suppressed and decrease in S/N can be prevented with a signal having a smaller value.

### SUMMARY OF THE INVENTION

In order to achieve the objects, the solid-state imaging device according to the present invention includes: an imaging unit including pixels arranged in rows and columns; column amplifying units each configured to amplify a column signal with a variable gain, each of the column amplifying units being provided for each column of the imaging unit, and the column signal representing a signal component and a reference component; column sample-hold units each configured to selectively sample-hold and pass the column signal, each of the sample-hold units being provided for each column of the imaging unit, the column signal being amplified by a corresponding one of the column amplifying units; column AD conversion units each configured to convert the column signal to a digital signal using a ramp signal, the column signal being read from a corresponding one of the column sample-hold units, and the digital signal corresponding to a difference between the signal component and the reference component; and a gain control unit configured to specify a gain for each of the column amplifying units, wherein each of the column amplifying units is configured to amplify a corresponding one of the column signals with a corresponding one of the gains specified by the gain control unit, and the column amplifying units, the column sample-hold units, and the gain control unit are formed on a semiconductor substrate.

Thereby, since the column amplifying units using a variable gain are provided in a pre-processing circuit of the column AD conversion units, a lower voltage of the column signal can be amplified, and decrease in S/N in the column AD conversion units can be prevented. However, the column signal to be converted to a digital signal immediately after the amplification generates RTS noise depending on amplitude of the signal as described above. In order to solve the problem, since the column sample-hold units are provided prior to each of the column AD conversion units, a sampling period of each of the column signals can be set to a shorter period and the RTS noise can be suppressed.

Here, the gain control unit preferably specifies a gain for each of the column amplifying units so that amplitude of each of the column signals is optimized in an input range of the column AD conversion units. More specifically, the gain control unit preferably specifies a larger gain for each of the column amplifying units as the amplitude of each of the column signals is smaller so that the amplitude of each of the column signals is optimized in the input range of the column AD conversion units. Here, optimizing a signal “to an input range” refers to amplification of a lower signal to a signal having amplitude closer to the input range, for example 50 to 100% of the full-scale range.

Thereby, a gain for each of the column amplifying units can be adaptively and automatically adjusted to the column signals having various amplitude, and even after the conversion of column signals to digital signals, S/N of pixel signals can be maintained as higher values, independent of amplitude of each of the column signals.

Furthermore, the gain control unit preferably specifies a gain according to the digital signal read from each of the column AD conversion units. For example, in order to convert a column signal to a digital signal next time, a gain for a column amplifying unit is optimized according to a digital value of the column AD conversion unit immediately prior or prior to the current column AD conversion unit. Thereby, a gain is optimized according to a column signal that varies according to the passage of time, and S/N of a pixel signal is always maintained favorably.

Furthermore, the gain control unit preferably specifies a gain when each of the column signals represents the signal component other than the reference component. This is because the column amplifying unit amplifies only the signal component other than the reference component during when the column signals are provided, and generates a signal in which the reference component is added to the amplified signal component. However, during other periods, the column amplifying unit generates the reference component of the column signal. Furthermore, each of the column sample-hold units preferably sample-holds a corresponding one of the column signals only during a predetermined sampling period independent of amplitude of the signal component. A column signal is sample-held at a point in time when: the column signal represents a reference component; a signal corresponding to the reference component is converted to a digital signal; or a predetermined time has passed since the column signal represents a signal component, for example. Thereby, a column signal is sample-held during a short sampling period during when the column signal is converted to a digital signal in each of the column AD conversion units. Thus, compared to the conventional techniques of sample-holding the signal for a longer period of the conversion, RTS noise can be further suppressed.

Each of the column sample-hold units preferably sample-holds the signal component, and passes or sample-holds the reference component. Thereby, after the reference component of the column signal is converted to a digital signal, the signal component of the column signal is converted to a digital signal, and each of the column AD conversion units generates a difference signal corresponding to a difference between the reference component and the signal component. As a result, the digital CDS can be realized.

Each of the column AD conversion units preferably includes: a comparator that compares the column signal with a reference signal having a ramp waveform; and a counter that measures a time elapsed from a time when the reference signal is applied to the comparator to a time when an output signal from the comparator is inverted, and the counter counts down or up a clock signal during a period when a corresponding one of the column signals represents the reference component for obtaining an initial value, and counts up or down the clock signal during a period when the corresponding one of the column signals represents the signal component. Thereby, one up-down counter provided per column of the imaging unit calculates a difference between the signal component and the reference component of each of the column signals, realizing the digital CDS easily without additional circuits, such as a subtracter and a memory.

The present invention can be realized not only as a solid-state imaging device having the aforementioned characteristics, but also as a driving method of the same, for example, a driving method including: specifying a gain for each of the column amplifying units so that amplitude of each of the column signals is optimized in an input range of the column AD conversion units; and controlling each of the column sample-hold units so as to sample-hold a corresponding one of the column signals only during a predetermined sampling period independent of amplitude of the signal component.

The solid-state imaging device and the driving method of the same of the present invention can implement the digital CDS that can favorably maintain S/N after converting a column signal to a digital signal, and suppress influence of RTS noise to be added to a pixel signal as well.

Thus, according to the present invention, various noises that may occur in a solid-state imaging device can be reduced, and a dynamic range for one screen image can be expanded. In particular, the present invention is highly suitable for practical use today where a clear image can be captured without varying in an intensity level under low light conditions by digital cameras that are made widely available.

### FURTHER INFORMATION ABOUT TECHNICAL BACKGROUND TO THIS APPLICATION

The disclosure of Japanese Patent Application No. 2007-334884 filed on Dec. 26, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 illustrates a circuit block diagram of the solid-state imaging device according to the present invention;

FIG. 2 is a circuit drawing illustrating a structure of pixels;

FIG. 3 is a circuit drawing illustrating a detailed structure of the column amplifying units and the column sample-hold units;

FIG. 4 shows a timing chart of the operations of the column amplifying units;

FIG. 5 shows a timing chart of the operations of the column sample-hold units;

FIG. 6 illustrates a reference drawing of a structure of the solid-state imaging device according to the present invention;

FIG. 7 illustrates a functional block diagram of a camera including the solid-state imaging device according to the present invention;

FIGS. 8A and 8B illustrate outline views of a camera as examples of FIG. 7;

FIG. 9 illustrates a circuit block diagram of a conventional solid-state imaging device; and

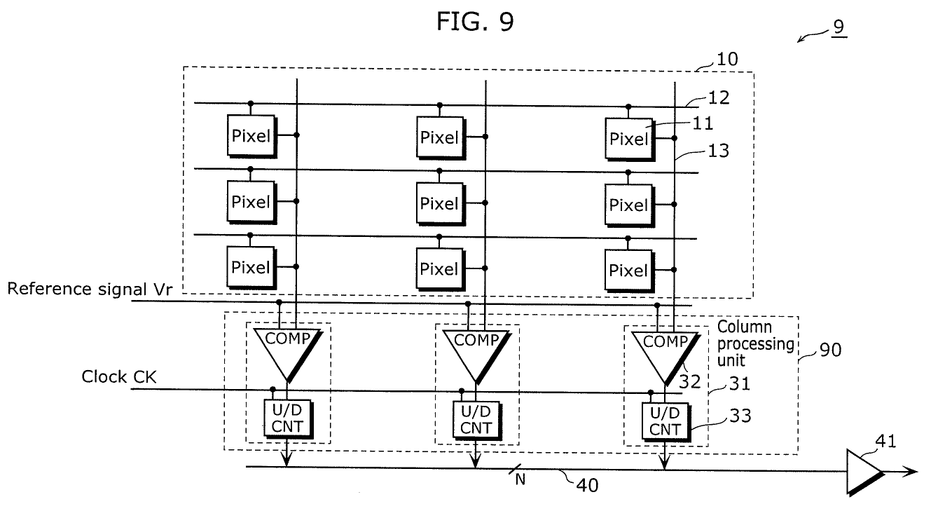

FIG. 10 is a timing chart for explaining a problem of the conventional solid-state imaging device.

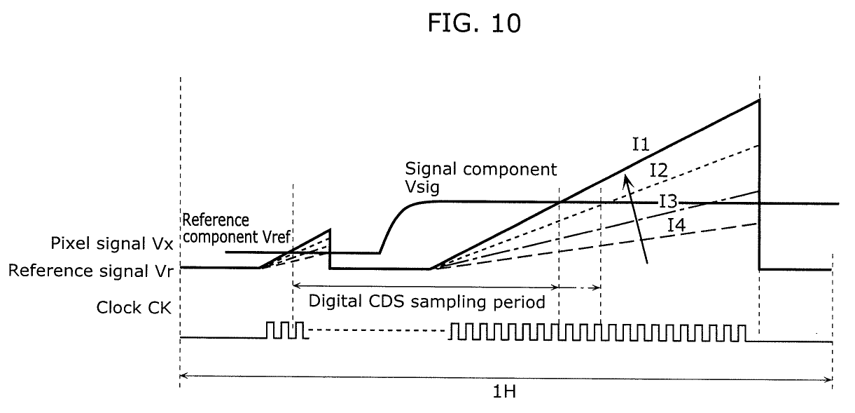

### DESCRIPTION OF THE PREFERRED EMBODIMENT

Hereinafter, the solid-state imaging device and the driving method of the same according to the present invention will be described with reference to drawings in detail.

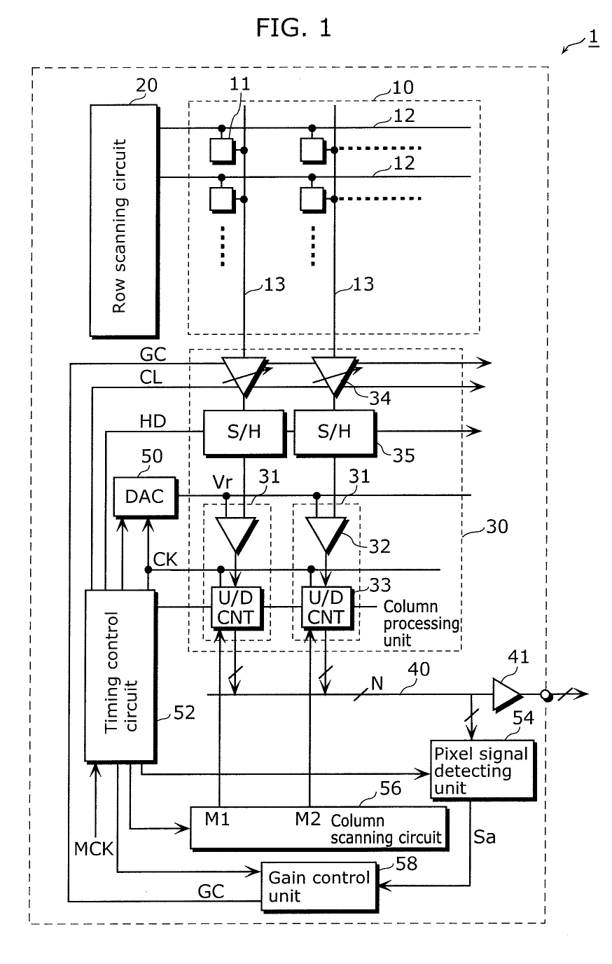

FIG. 1 is a circuit block diagram illustrating a structure of a solid-state imaging device 1 according to the present invention. The solid-state imaging device 1 is a MOS image sensor including column AD conversion units using a digital CDS, and is characterized by suppressing RTS noise and preventing decrease in S/N when even a signal having a smaller value is converted to a digital signal. The solid-state imaging device 1 includes an imaging unit 10, a row scanning circuit 20, a column processing unit 30, an output circuit 41, a DA conversion unit 50, a timing control circuit 52, a pixel signal detecting unit 54, a column scanning circuit 56, and a gain control unit 58.

The imaging unit 10 includes pixels 11 that are arranged in rows and columns, and generates a signal from a corresponding one of the pixels 11 in a row selected by one of the row selecting lines 12 to each of column signal lines 13, so that a column signal (or referred to as pixel signal) corresponding to an amount of light incident on the pixel 11 is transmitted to each row. This column signal includes a reference component corresponding to an offset voltage for resetting the pixel 11, and a signal component corresponding to a voltage obtained by adding a component corresponding to a voltage generated according to light incident on the pixel 11 to the reference component.

The row scanning circuit 20 is a shift register and the like that sequentially generates to the row selecting lines 12 a row selection signal for reading a signal in each of the pixels 11 of the imaging unit 10 per row.

The column processing unit 30 is a circuit that converts each column signal into a digital signal using a digital CDS, and includes, on each of the column signal lines 13, a column amplifying unit 34, a column sample-hold unit 35, and a column AD conversion unit 31. This column processing unit 30 is different from the column processing unit 90 included in the conventional solid-state imaging device 9 in having the column amplifying units 34 and the column sample-hold units 35 as pre-process circuits of each of the column AD conversion units 31.

The column amplifying unit 34 is a switched capacitor filter (SCF) amplifier that amplifies a pixel signal component with a variable gain specified by a gain control signal GC provided from the timing control circuit 58 and that selectively switches output of a reference voltage of the column amplifying unit 34 depending on an AMP clear signal CL from the timing control circuit 52. The column amplifying unit 34 generates the reference voltage of the column amplifying unit 34 according to the AMP clear signal CL. Furthermore, when a column signal represents a signal component, the column amplifying unit 34 amplifies a difference between the signal component and the reference component with a gain specified by the gain control signal GC, and generates a resulting signal obtained by adding the amplified difference to the reference voltage.

The column sample-hold unit 35 selectively sample-holds and passes a column signal provided from the column amplifying unit 34, according to a hold signal HD provided from the timing control circuit 52. More specifically, when a column signal represents a reference component provided from the column amplifying unit 34, the column sample-hold unit 35 passes the reference signal, and when a column signal represents a difference signal component, the column sample-hold unit 35 sample-holds the column difference signal for a predetermined sampling period.

The column AD conversion unit 31 generates a digital value corresponding to a difference between a reference component and a signal component by converting a column signal representing the reference component and the signal component to a digital signal using a ramp signal. The difference is a net signal corresponding to an amount of light incident on each of the pixels 11. Each of the column AD conversion units 31 includes the comparator 32 and the up-down counter 33. Here, a ramp signal that has a ramp waveform and causes a voltage to rise at a certain slope is set when an analog signal is applied to the column AD conversion unit 31. Then, the up-down counter 33 measures a time elapsed from a time when the ramp signal is set to a time when voltages of the analog signal and the ramp signal match, and converts the measured time to a digital value. The comparator 32 compares a voltage of a column signal with a voltage of a reference signal Vr received as a ramp signal and generates a signal representing timing when the voltage of the reference signal Vr matches the voltage of the column signal. The up-down counter 33 counts down (or counts up) a clock signal during a period elapsed from a time when the reference signal Vr is applied to the comparator 32 to a time when the reference signal Vr reaches a voltage of a column signal representing a reference component, and then counts up (or counts down) the clock signal during a period elapsed from a time when the reference signal Vr is applied to the comparator 32 to a time when the reference signal Vr reaches a voltage of a column signal representing a signal component. Thereby, the up-down counter 33 can hold a digital value corresponding to a difference between the signal component and the reference component of the column signal.

The digital values held by each of the up-down counters 33 are respectively transmitted to the horizontal signal line 40 including N buses, and the digital values are transmitted outside via the output circuit (output buffer) 41.

The DA conversion unit 50 is a ramp signal generating circuit that supplies the reference signal Vr to each of the comparators 32 under control of the timing control circuit 52.

The timing control circuit 52 is a circuit that controls operation timing of each circuit element. The timing control circuit 52 controls, for example: timing for connecting and/or disconnecting input and output terminals by synchronizing with a master clock MCK to be supplied from outside, and transmitting an AMP clear signal CL to the column amplifying units 34; timing for sample-holding by transmitting a hold signal HD to the column sample-hold units 35; timing for causing the DA conversion unit 50 to generate a ramp signal; timing for causing the pixel signal detecting unit 54 to detect a pixel signal; timing for providing column selection signals M1 and M2 to the column scanning circuit 56; and timing for providing the gain control signal GC to the gain control unit 58.

The column scanning circuit 56 is a shift register that sequentially transmitting to each of the up-down counters 33 the column selection signals M1, M2, . . . , and Mn that enable output to each of the up-down counters 33 under control of the timing control circuit 52 so as to cause each of the up-down counters 33 to sequentially transmit digital values held by each of the up-down counters 33 to the horizontal signal line 40.

The pixel signal detecting unit 54 and the gain control unit 58 are control circuits that specify a gain for each of the column amplifying units 34 in order to optimize amplitude of the column difference signal amplified by each of the column amplifying units 34 in an input range of the column AD conversion units 31. As a method for specifying a gain for each of the column amplifying units 34, the embodiment employs an algorithm that specifies a gain for the column amplifying units 34 for capturing a next frame, by calculating an average of pixel signals in a frame immediately prior or prior to a current frame so that the average falls within 50 to 100 percent of a full-scale input to the column AD conversion units 31.

Thus, the pixel signal detecting unit 54 calculates an average value of pixel signals of one frame that are transmitted to the horizontal signal line 40 (corresponding to digital signals transmitted from the up-down counter 33) by monitoring the pixel signals and generates an average pixel signal Sa indicating the average value to the gain control unit 58. Here, the target frame for calculating the average value is a frame immediately prior or prior to a frame to which a new gain is applied. In the case of capturing a still image, the target frame is a frame preliminarily captured and present immediately prior or prior to a frame to which a new gain is applied. On the other hand, in the case of capturing a moving image, the target frame is included in succeeding frames immediately prior or prior to a frame to which a new gain is applied. Here, the method for calculating an average value of pixel signals from succeeding frames of an moving image is used for calculating a moving average, for example, a simple moving average, a weighted moving average, and an exponential smoothing moving average.

The gain control unit 58 generates the gain control signal GC corresponding to the average pixel signal Sa transmitted from the pixel signal detecting unit 54, to each of the column amplifying units 34. More specifically, the gain control unit 58 generates the gain control signal GC to each of the column amplifying units 34 so that a gain for each of the column amplifying units 34 becomes larger as the received average pixel signal Sa has a smaller value than a full-scale input to the column AD conversion unit 31. For example, when the full-scale input to the column AD conversion units 31 is 1024, the gain control unit 58 transmits, to each of the column amplifying units 34, the gain control signal GC specifying a gain for causing the current average pixel signal Sa to fall within a range of 512 to 1024 (for example, when the current average pixel signal Sa indicates 200, the gain to be specified is equivalent to 4 times larger than the current gain).

As illustrated in FIG. 1, the solid-state imaging device 1 includes circuits that specify a gain for the column amplifying units 34 (the pixel signal detecting unit 54 and the gain control unit 58). In other words, the circuits that specifies a gain for the column amplifying units 34 (the pixel signal detecting unit 54 and the gain control unit 58), the column amplifying units 34, and the column sample-hold units 35 are formed on a semiconductor substrate (semiconductor chip), to put it differently, are made into one chip.

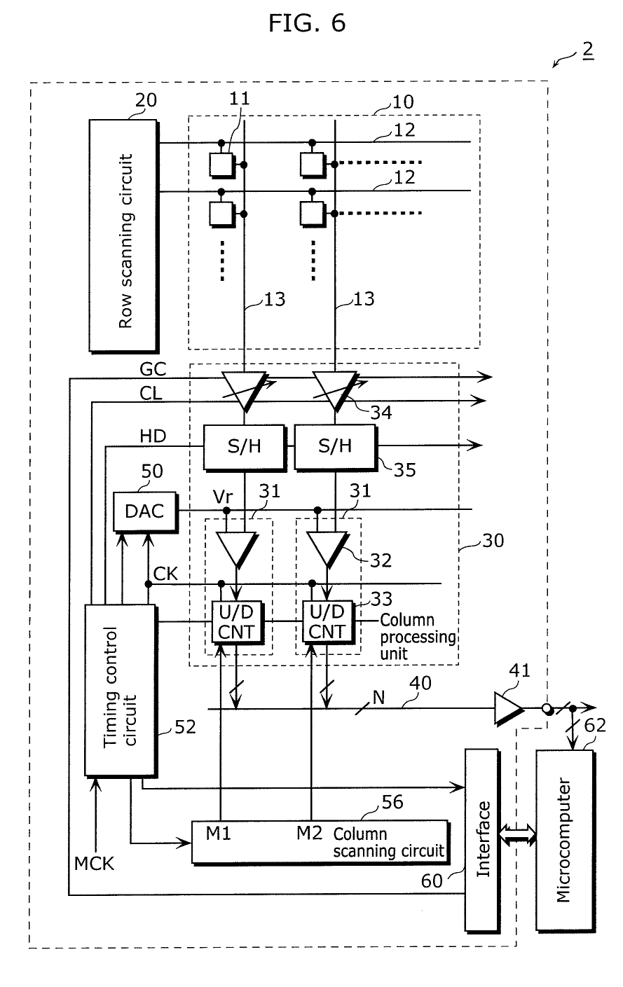

The reason why the elements are made into one chip is because in the case of installation of circuits that specify a gain for column amplifying units outside the solid-state imaging device as illustrated in the reference drawing of FIG. 6, there are disadvantages that: (i) noise easily enters through a signal line specifying a gain for each of the column amplifying units from outside the solid-state imaging device; (ii) noise caused by a digital signal occurs when a gain is controlled using the digital signal from the outside in the column amplifying unit; and (iii) an external device or circuit needs processing for specifying a gain for each of the column amplifying units.

Here, in FIG. 6, a solid-state imaging device 2 includes an interface 60 and a microcomputer 62 as a replacement for the pixel signal detecting unit 54 and the gain control unit 58 included in the solid-state imaging device 1 illustrated in FIG. 1. The interface 60 is an input and output port for the solid-state imaging device 2 to communicate with the microcomputer 62. The microcomputer 62 is a processor installed outside the solid-state imaging device 2, and controls an entire apparatus including the solid-state imaging device 2.

As described above, the solid-state imaging device 1 in FIG. 1 according to the present invention is different from the solid-state imaging device 2 in FIG. 6 in having circuits that specify a gain for each of the column amplifying units 34 (the pixel signal detecting unit 54 and the gain control unit 58). Thereby, noise entering through a signal line specifying a gain for each of the column amplifying units 34 can be suppressed, in particular, RTS noise and noise from outside can be suppressed in a sophisticated manner.

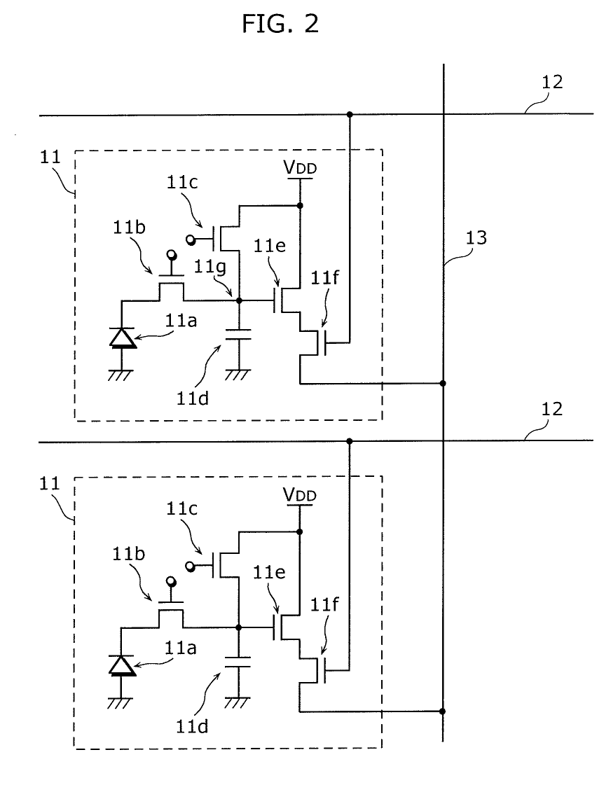

FIG. 2 is a circuit drawing illustrating details of the pixels 11 in FIG. 1. Each of the pixels 11 corresponds to a unit cell included in the imaging unit 10 in FIG. 1, and includes a photodiode (PD) 11a that generates charges through photo electric conversion of light incident on the pixel 11; a capacitor 11d (floating diffusion referred to as FD) that accumulates the charges generated in the PD 11a and generates a voltage signal corresponding to the accumulated charges; a reset transistor (NMOS transistor) 11c that resets the voltage specified by the capacitor 11d to an initial voltage (here, VDD); a transfer transistor 11b that transfers the charges generated in the PD 11a to the capacitor 11d; an amplification transistor 11e that generates a voltage that varies according to a voltage specified by the capacitor 11d; and a selection transistor 11f that applies an output of the amplification transistor 11e to the column signal line 13 in response to a row selection signal provided from the row selecting line 12.

In each of the pixels 11 having such structure, with the selection of one of the pixels 11 by the row selecting line 12, a pulse is applied to a gate of the reset transistor 11c to be turned on only during a predetermined period of time. Then, the voltage specified by the capacitor 11d is reset to the initial voltage VDD. Then, a potential at a node 11g is applied as a reference component to the column signal line 13 through the amplification transistor 11e and the selection transistor 11f.

Then, a pulse is applied to a gate of the transfer transistor 11b to be turned on only during a predetermined period of time. Then, the charges generated in the PD 11a are transferred to the capacitor 11d, and the potential at the node 11g is applied as a signal component to the column signal line 13 through the amplification transistor 11e and the selection transistor 11f. As described above, upon completion of reading the reference component and the signal component from the pixels 11 included in one line to the column signal line 13, the same reading operation is performed in the pixels 11 included in the next line. With repetition of reading the pixels 11 on a line unit basis, all lines (corresponding to one frame) are read within a vertical period.

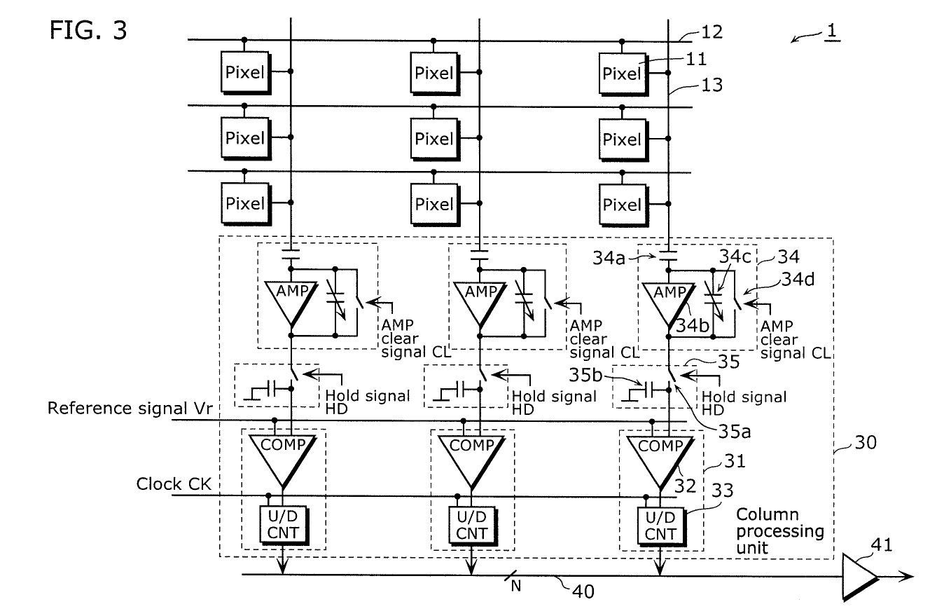

FIG. 3 is a circuit drawing illustrating the detailed structure of the column amplifying units 34 and the column sample-hold units 35 that characterize the solid-state imaging device 1 in FIG. 1 most.

Each of the column amplifying units 34 includes a coupling capacitor 34a, an amplifier 34b, a variable capacitance capacitor 34c, and a switching element 34d. The coupling capacitor 34a is a capacitor that couples the column signal line 13 and the amplifier 34b. The amplifier 34b is a voltage amplifier. The variable capacitance capacitor 34c is a variable capacitance element that is coupled between input and output terminals of the amplifier 34b and that varies capacitance according to the gain control signal GC transmitted from the gain control unit 58. The switching element 34d is a MOS transistor that is coupled between the input and output terminals of the amplifier 34b and that connects or disconnects the input and output terminals of the amplifier 34b according to the AMP clear signal CL transmitted from the timing control circuit 52. This switching operation enables the amplifier 34b to provide a reference voltage of the amplifier, and the amplifier 34b and the variable capacitance capacitor 34c to operate as a variable gain amplifier.

In this column amplifying unit 34, when the switching element 34d is turned off, a voltage of a column signal provided from the signal line 13 is divided according to the capacitance of the coupling capacitor 34a, the variable capacitance capacitor 34c, and the hold capacitor 35b, and the divided voltage is applied to the column AD conversion unit 31 (in other words, the comparator 32). Thus, according to the capacitance of the variable capacitance capacitor 34c, a capacitance division ratio, in other words, a gain varies.

Each of the column amplifying units 34 having such structure passes a reference component provided from the column signal 13, and amplifies a signal component of the column signal with an appropriate gain so that amplitude of the column signal to be applied to the column AD conversion unit 31 is optimized in the input range (in other words, input range of the comparators 32). Thereby, even when the column signal read from the imaging unit 10 represents a low voltage, the column signal is amplified appropriately by the column amplifying unit 34, and is transmitted to the comparator 32. Thus, the comparator 32 compares signals representing relatively higher voltages (for example, voltages of 50 to 100% of the input range), and the comparison is performed with higher precision and stability, preventing decrease in S/N due to a smaller signal component.

Each of the column sample-hold units 35 includes the switching element 35a and the hold capacitor 35b. The switching element 35a is a MOS transistor to be connected between an output terminal of the column amplifying unit 34 and an input terminal of the column AD conversion unit 31, and is turned on or off according to a hold signal HD transmitted from the timing control circuit 52. The hold capacitor 35b is a capacitor for sample-holding the signal component of the column signal transmitted from the column amplifying unit 34.

When the column signal transmitted from the column amplifying unit 34 represents a reference component, the column sample-hold unit 35 having such structure passes the column signal. On the other hand, when the column signal represents a signal component, the column sample-hold unit 35 sample-holds the column signal at an early stage where the signal component becomes stable (in other words, during a predetermined period specified by the hold signal HD). Thereby, the switching element 35a is changed from on to off. Then, a sampling period (a period during when the switching element 35a is turned on) becomes a predetermined short period independent of the amplitude of the signal component, in other words, a period shorter than a period until when a voltage of the reference signal Vr to be applied to the comparator 32 reaches a voltage of the pixel signal Vx. Thereby, compared to the conventional techniques, RTS noise can be further suppressed.

Next, operations of the solid-state imaging device 1 having the aforementioned structure will be described.

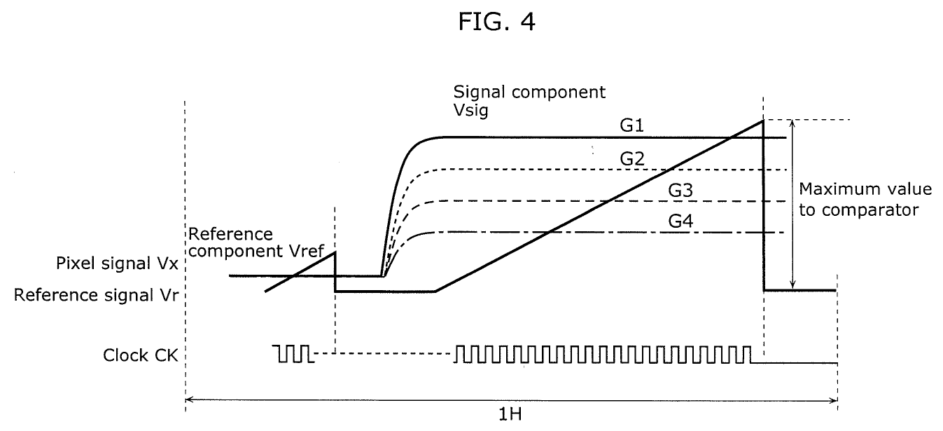

FIG. 4 shows a timing chart of the operations of the column amplifying units 34 of the solid-state imaging device 1. Here, FIG. 4 shows the output signal of the column amplifying units 34, in other words, timing of: the pixel signal Vx that is one of input signals to the comparators 32; the reference signal Vr that is the other input signal to the comparators 32: and the clock CK to be applied to the up-down counters 33.

As shown in levels G1 to G4 of the signal component Vsig in FIG. 4, the column amplifying units 34 changes capacitance of the variable capacitance capacitor 34c according to the gain control signal GC, and amplifies a signal component Vsig of the column signal with an appropriate gain so that the amplitude of the column signal to be applied to the column AD conversion unit 31 is optimized in the input range (in other words, input range of the comparators 32).

The gain control unit 58 that transmits the gain control signal GC specifying the gain specifies a gain for the column amplifying units 34 so that amplitude of the column signal amplified by the column amplifying units 34 is optimized in the input range of the column AD conversion units 31 according to the average pixel signal Sa representing an average value of the pixel signals of one frame immediately prior or prior to a frame detected by the pixel signal detecting unit 54. For example, the gain control unit 58 transmits the gain control signal GC specifying a gain for the column amplifying units 34 so that the average voltage of the signal component Vsig in one frame falls within 50 to 100% of the input range of the column AD conversion units 31. Thereby, even when the column signal read from the imaging unit 10 represents a low voltage, the column signal is amplified appropriately by the column amplifying unit 34, and is applied to the comparator 32. Thus, the comparator 32 compares signals representing relatively higher voltages (for example, voltages of 50 to 100% of the input range), and the comparison is performed with higher precision and stability, preventing decrease in S/N due to a smaller signal component.

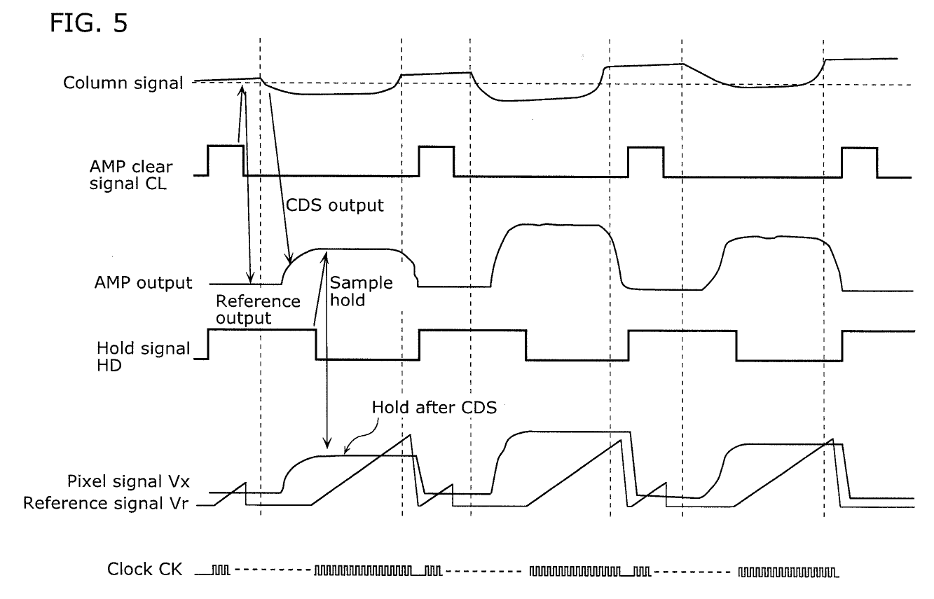

FIG. 5 shows a timing chart of operations of the column sample-hold units 35 of the solid-state imaging device 1. FIG. 5 illustrates timing of: the column signal read from the imaging unit 10 to the column signal line 13; the AMP clear signal CL that is a control signal to be applied to the column amplifying units 34; the output signal (AMP output) of the column amplifying units 34; the hold signal HD that is also a control signal to be applied to the column sample-hold units 35; the column signal applied to the comparators 32 (pixel signal Vx) and the reference signal Vr; and the clock CK applied to the up-down counters 33.

During a period when the AMP clear signal CL is higher, the switching elements 34d of the column amplifying units 34 are turned on. Thus, the reference component of the column signal read from the imaging unit 10 to the column signal line 13 is sample-held by the coupling capacitors 34a, and during the period, the reference voltage of the column amplifying units 34 is read (“reference output” in FIG. 5). During this period, since the hold signal HD is high as shown in FIG. 5, the switching element 35a of the column sample-hold unit 35 is turned on. Then, the column signal representing the reference voltage is applied to the comparator 32 as the pixel signal Vx and is compared with the reference signal Vr. Then, the up-down counter 33 counts down (or counts up) a count value corresponding to the amplitude of the reference voltage and holds the count value.

Next, when the AMP clear signal CL becomes low, the column amplifying unit 34 operates as a voltage amplifier with a gain corresponding to the gain control signal GC. Then, the column signal including the signal component is read from the imaging unit 10 to the column signal line 13, a signal obtained by subtracting the reference component from the signal component is amplified, and the signal is added to the AMP output, and then the voltage is generated (“CDS output” in FIG. 5).

When the hold signal HD that has been high for only a certain period becomes low, the switching element 35a of the column sample-hold unit 35 is turned off, and the column signal representing a difference signal component amplified by the column amplifying unit 34 is sample-held by the hold capacitor 35b (“Sample hold” in FIG. 5). Here, a period when the hold signal HD becomes high corresponds to a certain period of time, for example, from a point in time: when the AMP clear signal CL becomes high; when the AMP reference output is converted to a digital signal; when the AMP clear signal CL becomes low; or when the column signal indicates the difference signal component.

As soon as the reference signal Vr applied to the comparators 32 starts to rise, each of the up-down counters 33 starts to count up the clock CK using the count value obtained by counting down (or counting up) as an initial value.

As soon as the reference signal Vr reaches a voltage corresponding to the signal component held by the hold capacitor 35b, the comparator 32 notifies the up-down counter 33 of the timing, and the notified up-down counter 33 suspends the counting up (or counting down) and holds the final count value. A digital signal each corresponding to the held count value is transmitted to the horizontal signal line 40 (N buses) sequentially using the column selection signal M1 and other signals from the column scanning circuit 56, and is transmitted to outside via the output circuit (output buffer) 41.

The column signal representing the signal component Vsig is accumulated (in other words, sample-held) in the hold capacitors 35b only during a certain period of time when the hold signal HD is higher in the column sample-hold units 35. When the hold signal HD becomes lower, the voltage of the hold capacitors 35b is sample-held. Then, the voltage is compared with the reference signal Vr by the comparators 32. Thereby, the sampling period may be limited to a predetermined short period independent of the amplitude of the signal component, in other words, to a period shorter than a period until when a voltage of the reference signal Vr to be applied to the comparators 32 reaches a voltage of the column signal. Thus, the RTS noise can be further suppressed as the sampling period becomes shorter, and in particular, the problem of varying in an intensity level (flicker of light) under low light conditions can be prevented.

In general, when an input signal is converted to a digital signal using a ramp signal, there is a problem that the larger the voltage of the input signal becomes, the longer the time for the conversion is necessary, and the influence of RTS noise increases. However, the solid-state imaging device according to the embodiment can solve the problem because the column sample-hold unit sample-holds a component for a certain period of time independent of amplitude of the voltage of the input signal. Furthermore, the column sample-hold unit can separate timing of a pre-process circuit including column amplifying units from timing of a post-process circuit including column AD conversion units, so that the pre-process and the post-process circuits can be pipelined and the operations can be performed at higher speed.

Furthermore, the solid-state imaging device according to the embodiment includes column amplifying units using a variable gain. Thereby, a voltage of an input signal applied to the column AD conversion units is optimized to an appropriate value and the S/N to the random noise is improved. Furthermore, since the column amplifying units are provided prior to the column sample-hold units, the signal amplified to an appropriate voltage is applied to the column sample-hold units with certainty, and an error that may occur in the column sample-hold unit when column signals have a smaller value can be suppressed.

As described above, in the solid-state imaging device according to the present invention, the column amplifying units that use variable gains and are provided for each column of an imaging unit, the column sample-hold units, and the column AD conversion units using a ramp signal organically and complementarily interact with each other. As a result, the RTS noise can be suppressed, and decrease in S/N can be prevented even when a signal having a smaller value is converted to a digital signal by a column AD conversion unit.

As described above, although the solid-state imaging device and the driving method of the same according to the present invention are described, the present invention is not limited to the aforementioned embodiment.

Furthermore, as a method for specifying a gain for each of the column amplifying units 34, the embodiment employs an algorithm of specifying a gain for each of the column amplifying units 34 so that an average value of pixel signals of a next frame falls within 50 to 100% of a full-scale input to the column AD conversion units 31. However, the present invention is not limited to such algorithm.

For example, when an average value of pixel signals of a next frame is estimated from variations of average values of the pixel signals in a plurality of frames immediately prior or prior to the current frame, a gain for the column amplifying units 34 may be specified so that the estimated average value becomes a value having a predetermined proportion to the full-scale input to the column AD conversion units 31. For example, when an average value of pixel signals of a next frame is estimated by inserting an average value of pixel signals of two frames immediately prior or prior to the current frame, an optimal gain may be selected from among a plurality of gains held by the column amplifying units 34 so that the estimated average value becomes a value corresponding to 75% of the full-scale input to the column AD conversion units 31. Thereby, the gain for the column amplifying units 34 may be optimized according to pixel signals that temporally vary.

Furthermore, the reference information for specifying a gain for the column amplifying units 34 is not limited to an average value of pixel signals for each frame. The information may include values, such as a maximum value, a minimum value, a median value of pixel signals, and a value calculated using the maximum value, the minimum value, and the median value. Here, the pixel signals are of all pixels that compose a frame or are of part of the pixels. Furthermore, a gain for the column amplifying units 34 may be specified using intensity information obtained by measuring intensity using a sensor different from the imaging unit 10 (luminous intensity sensor, for example). This is because any information is useful for optimizing a gain for each of the column amplifying units 34.

Furthermore, although the sampling period in the column sample-hold units 35 is a predetermined period during which the hold signal HD transmitted from the timing control circuit 52 is high in the embodiment, the period may be determined according to various methods. For example, the timing control circuit 52 may transmit the AMP clear signal CL by setting it to high. Simultaneously, the timing control circuit 52 may transmit the hold signal HD by setting it to high, and then after a predetermined period of time, transmit the hold signal HD by setting it to low. Alternatively, the timing control circuit 52 may control the sampling period depending on the amplitude of the signal component of a column signal. More specifically, upon being notified of the gain control signal GC from the gain control unit 58, the timing control circuit 52 may transmit the hold signal HD so that the sampling period becomes shorter as the gain specified by the gain control signal GC is higher (voltage of the column signal is lower). Thereby, the sampling period is optimized and the RTS noise can be further suppressed.

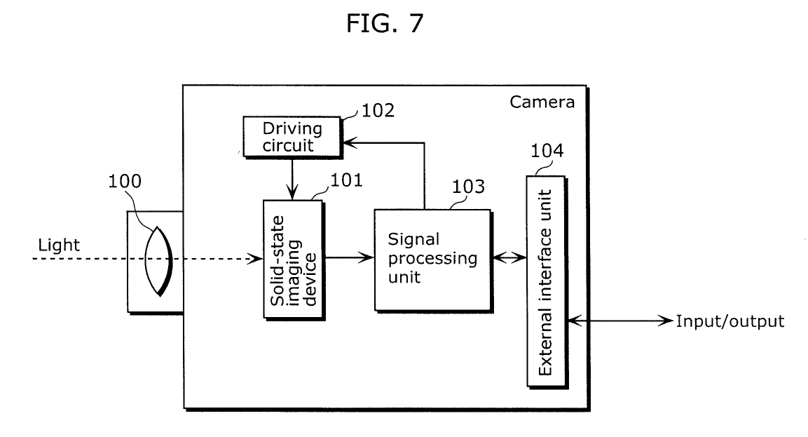

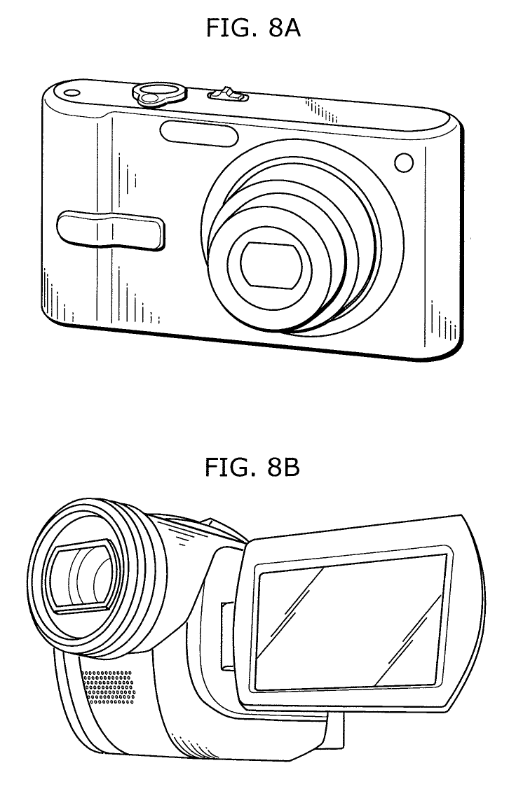

Furthermore, obviously, the present invention includes various electronic devices including the solid-state imaging device according to the present invention. For example, as the functional block diagram in FIG. 7, the present invention includes a camera including a solid-state imaging device 101 (solid-state imaging device 1 or 2 in the embodiment). This camera includes a lens 100, the solid-state imaging device 101, a driving circuit 102, a signal processing unit 103 (corresponding to the row scanning circuit 20 and column scanning circuit 56 according to the embodiment, and/or a circuit that controls the row scanning circuit 20 and column scanning circuit 56), and an external interface unit 104, as illustrated in FIG. 7. Light passes through the lens 100 and enters the solid-state imaging device 101. The signal processing unit 103 drives the solid-state imaging device 101 through the driving circuit 102, and obtains an output signal from the solid-state imaging device 101. The signal processing unit 103 performs various signal processing on the output signal, and transmits the signal outside through the external interface unit 104. Since such camera includes a solid-state imaging device that can perform digital CDS with a low RTS noise and a higher S/N. Thereby, a clear image can be captured without varying in an intensity level under low light conditions. Such camera can be achieved as a digital still camera as illustrated in FIG. 8A and a video camera as illustrated in FIG. 8B. In FIG. 7, the solid-state imaging device 101, the driving circuit 102, the signal processing unit 103, and the external interface unit 104 may be combined accordingly to make them into one chip.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The solid-state imaging device according to the present invention is useful as an image sensor of various imaging apparatuses, such as a digital still camera, a video camera, and a monitoring camera. Here, the image sensor can generate a stable pixel signal with less noise and without varying in an intensity level under low light conditions.

What is claimed is:

1. A solid-state imaging device, comprising:
an imaging unit including pixels arranged in rows and columns;
column amplifying units each configured to amplify a column signal with a variable gain, each of said column amplifying units being provided for each column of the imaging unit, and the column signal representing a signal component and a reference component;
column sample-hold units each configured to selectively sample-hold and pass the column signal, each of said sample-hold units being provided for each column of the imaging unit, the column signal being amplified by a corresponding one of said column amplifying units;
column AD conversion units each configured to convert the column signal to a digital signal using a ramp signal, the column signal being read from a corresponding one of said column sample-hold units, and the digital signal corresponding to a difference between the signal component and the reference component; and
a gain control unit configured to specify a gain for each of said column amplifying units,
wherein each of said column amplifying units is configured to amplify a corresponding one of the column signals with a corresponding one of the gains specified by said gain control unit, and
said column amplifying units, said column sample-hold units, and said gain control unit are formed on a semiconductor substrate.

2. The solid-state imaging device according to claim 1,
wherein said gain control unit is configured to specify a gain for each of said column amplifying units so that amplitude of each of the column signals is optimized in an input range of said column AD conversion units.

3. The solid-state imaging device according to claim 2,
wherein said gain control unit is configured to specify a larger gain for each of the column amplifying units as the amplitude of each of the column signals is smaller so that the amplitude of each of the column signals is optimized in the input range of said column AD conversion units.

4. The solid-state imaging device according to claim 2,
wherein said gain control unit is configured to specify a gain according to the digital signal read from each of said column AD conversion units.

5. The solid-state imaging device according to claim 2,
wherein said gain control unit is configured to specify a gain when each of the column signals represents the signal component other than the reference component.

6. The solid-state imaging device according to claim 1,
wherein each of said column sample-hold units is configured to sample-hold a corresponding one of the column signals only during a predetermined sampling period independent of amplitude of the signal component.

7. The solid-state imaging device according to claim 1,
wherein each of said column sample-hold units is configured to sample-hold the signal component, and to pass or sample-hold the reference component.

8. The solid-state imaging device according to claim 1,
wherein each of said column AD conversion units includes:
a comparator that compares the column signal with a reference signal having a ramp waveform; and
a counter that measures a time elapsed from a time when the reference signal is applied to said comparator to a time when an output signal from said comparator is inverted, and
said counter counts down or up a clock signal during a period when a corresponding one of the column signals represents the reference component for obtaining an initial value, and counts up or down the clock signal during a period when the corresponding one of the column signals represents the signal component.

9. A method for driving a solid-state imaging device that includes: an imaging unit including pixels arranged in rows and columns; column amplifying units each amplifying a column signal with a variable gain, each of the column amplifying units being provided for each column of the imaging unit, and the column signal representing a signal component and a reference component; column sample-hold units each selectively sample-holding and passing the column signal, each of the sample-hold units being provided for each column of the imaging unit, the column signal being amplified by a corresponding one of the column amplifying units; column AD conversion units each converting the column signal to a digital signal using a ramp signal, the column signal being read from a corresponding one of the column sample-hold units, and the digital signal corresponding to a difference between the signal component and the reference component; and a gain control unit specifying a gain for each of the column amplifying units, wherein each of the column amplifying units is configured to amplify a corresponding one of the column signals with a corresponding one of the gains specified by the gain control unit, and the column amplifying units, the column sample-hold units, and the gain control unit are formed on a semiconductor substrate, said method comprising:
specifying a gain for each of the column amplifying units so that amplitude of each of the column signals is optimized in an input range of the column AD conversion units; and
controlling each of the column sample-hold units so as to sample-hold a corresponding one of the column signals only during a predetermined sampling period independent of amplitude of the signal component.
